(19) United States
(12) Patent Application Publication
(10) Pub. No.: US 2015/0358539 A1
(43) Pub. Date: Dec. 10, 2015

(54) Mobile Virtual Reality Camera, Method, And System

(71) Applicant: Jacob Catt, Washington, DC (US)

(72) Inventor: Jacob Catt, Washington, DC (US)

(21) Appl. No.: 14/725,249

(22) Filed: May 29, 2015

Related U.S. Application Data
(60) Provisional application No. 62/008,526, filed on Jun. 6, 2014.

(51) Int. Cl. H04N 5/232; G06T 5/00; G06T 19/00; H04N 13/02

(52) U.S. Cl. CPC H04N 5/23238; H04N 13/025; G06T 5/006; G06T 19/006

(57) ABSTRACT

In one embodiment, a virtual reality camera comprises a left wide-angle lens in communication with a left digital image sensor, a right wide-angle lens in communication with a right digital image sensor, a storage device, a processor, and a memory. An image processing engine executes on the processor and is configured to process images captured by the left digital image sensor and the right digital image sensor to create a pannable stereoscopic view. In certain embodiments, the image processing engine may be further configured to de-warp the left image and the right image to create a panoramic left image and a panoramic right image, set an initial fixation point for the panoramic left image and the panoramic right image, and generate a left perspective view and a right perspective view from the panoramic left image and the panoramic right image to create the pannable stereoscopic view.

The present disclosure claims priority to U.S. Provisional Patent Application Ser. No. 62/008,526 for “Mobile Virtual Reality Camera, Method, and System”, filed Jun. 6, 2014, the disclosure of which is incorporated herein by reference.

### FIELD OF THE DISCLOSURE

The present disclosure relates generally to cameras, and in particular, relates to a virtual reality camera and system that captures three-dimensional pannable videos that can be viewed with a virtual reality headset.

### BACKGROUND

Cameras are well known in the art, and a variety of camera designs currently exist. Conventional digital cameras typically have a single digital image sensor and a lens. Light entering the lens is focused on to a digital image sensor, which creates an array of pixels, forming a digital image. The digital image may be stored locally on the camera or transferred to an external computer. Similarly, digital video cameras can convert incoming light through a lens into frames of a video, and combine the frames with sound recorded from a microphone. Because conventional cameras typically only have a single lens and sensor, they can only generate a single image for a given scene at a time. The result is that a typical digital camera can only present a three-dimensional (3D) scene in a two-dimensional (2D) format.

Humans have binocular vision, and use two eyes to perceive the world in three dimensions and better estimate distance. Binocular cues include stereopsis, wherein the differing projection of an object onto each retina of an eye is used to judge depth. Each view has a slightly different angle, thus making it possible for the human brain to triangulate the distance to an object with a high degree of accuracy due to the horizontal separation parallax of the human eyes. Among other cues, stereopsis provides humans with the ability to accurately perceive depth.

Conventional cameras only provide a monocular view because these cameras only capture a single image at a time. But some cameras have been created that capture two images simultaneously to create a stereoscopic, or binocular, view. For example, the Nintendo 3DS™ is an electronic consumer product that has two integrated cameras and an autostereoscopic screen that utilizes a parallax barrier to present a 3D view to an end user. Autostereoscopy refers to any method of displaying stereoscopic images without the use of special equipment by the viewer. In this case, the parallax barrier is placed in front of an LCD screen so that each eye only sees a separate set of pixels corresponding to left and right images. Thus, a stereo image captured by the two cameras can be presented in a simulated 3D view on the autostereoscopic screen.

However, current monocular cameras and cameras with stereoscopic lenses do not provide high resolution images with immersive, wide-angle views. Additionally, images are typically retained on the camera and not easily amenable to viewing elsewhere. Further, present cameras do not allow the stereoscopic view to be streamed to a separate viewing device in real-time. Finally, the resulting view is not truly immersive, because only the image itself is presented; there is no way to look beyond the edges of the image, because that is the extent of the captured image.

Currently, some of these issues are addressed in a variety of ways, with varying degrees of success. In some cases, the solutions to these issues are expensive, thereby raising the price of the camera and preventing it from being accessible to the average consumer. Thus there is a need for a camera that can address these issues in a cost effective manner.

### SUMMARY

The problems of the prior art are addressed by a novel virtual reality camera system. In one embodiment, the problems associated with current digital camera systems are solved by a virtual camera that uses two wide-angle fisheye lenses and image processing software to create a pannable 3D view. The resulting pannable 3D view can be displayed on a stereoscopic screen, 3D headset, or other appropriate 3D viewer. Because the resulting 3D view is pannable, it can be adjusted by an end user to look in any direction. The view may also be presented as a stored image or video, or live-streamed from the camera to the viewer.

In one embodiment, a virtual reality camera includes left and right wide-angle lenses in communication with left and right digital image sensors. The virtual reality camera features a processor, storage device, and memory. An image processing engine executing on the processor creates a captured stereoscopic image from the left and right sensors, creating a pannable 3D view. The pannable 3D view may be stored locally in a suitable file format, wirelessly transmitted to another computing device, or live-streamed to a 3D viewer. Further, the 3D viewer can be used to pan the view in any direction. For example, a head tracking unit can detect head movements and use this information to adjust the view accordingly.

In another embodiment, a virtual reality camera according to the disclosure comprises a left wide-angle lens in communication with a left digital image sensor, a right wide-angle lens in communication with a right digital image sensor, a storage device, a processor, and a memory. An image processing engine executing on the processor is configured to process a left image captured by the left digital image sensor and a right image captured by the right digital image sensor to create a pannable stereoscopic view. In certain embodiments, the left wide-angle lens and right wide-angle lens comprise a left ultra-wide-angle lens and a right ultra-wide angle lens. In certain embodiments, the image processing engine may be further configured to de-warp the left image and the right image to create a panoramic left image and a panoramic right image; set an initial fixation point for the panoramic left image and the panoramic right image; and create a left perspective view and a right perspective view from the panoramic left image and the panoramic right image, wherein each perspective view is a zoomed-in portion of each respective panoramic view with each respective fixation point at its center. In certain embodiments, the pannable stereoscopic view comprises the left perspective view and the right perspective view. In still further embodiments, the virtual reality camera further comprises an autostereoscopic screen. In these embodiments, the pannable stereoscopic view may be displayed in real-time on the autostereoscopic screen.

In another embodiment, a method of recording a three-dimensional (3D) video, comprises capturing, with a left wide-angle lens and a right wide-angle lens, a stereoscopic image comprising a left fisheye view and a right fisheye view, de-warping the left and right fisheye views by an image processing engine executing on a processor to create a left panorama view and a right panorama view, and setting an initial fixation point that corresponds to a single position within the left panorama view and the right panorama view. The method can further comprise creating a left frame within the left panorama view having the fixation point at the center of the frame, and a right frame within the right panorama view having the fixation point at the center of the frame, and presenting the left frame and right frame to a user within a 3D viewing apparatus. In certain embodiments, presenting the left frame and the right frame to a user comprises streaming the left frame and the right frame to an external server. In certain embodiments, the method further comprises updating, in response to user input, the fixation point to a new position, updating the left frame and right frame in response to the updated fixation point, and presenting the updated left frame and right frame to said user within said 3D viewing apparatus. In certain embodiments, user input can comprise a change in orientation of the user's view, or feedback received from a touch screen. In further embodiments, updating the left frame and right frame in response to the updated fixation point can comprise creating a left frame within the left panorama view having the updated fixation point at the center of the frame, and creating a right frame within the right panorama view having the updated fixation point at the center of the frame.

In another embodiment, a system for recording a three-dimensional (3D) video, comprises a left wide-angle lens in communication with a left digital image sensor, a right wide-angle lens in communication with a right digital image sensor, at least one 3D viewing apparatus, and an image processing engine executing on a processor. The image processing engine is configured to capture, with the left wide-angle lens and the right wide-angle lens, a stereoscopic image comprising a left fisheye view and a right fisheye view, de-warp the left and right fisheye views to create a left panorama view and a right panorama view, and set an initial fixation point that corresponds to a single position within the left panorama view and the right panorama view. The image processing engine may further be configured to create a left frame within the left panorama view having the fixation point at the center of the frame, create a right frame within the right panorama view having the fixation point at the center of the frame, and present the left frame and right frame to a user within the 3D viewing apparatus. In certain embodiments, the system can further comprise an external server, and presenting the left frame and the right frame to a user comprises streaming the left frame and the right frame to the external server. In certain embodiments, the 3D viewing apparatus may be configured to receive said left frame and said right frame from said external server. In certain embodiments, the image processing engine may be further configured to update, in response to user input, the fixation point to a new position, update the left frame and right frame in response to the updated fixation point, and present the updated left frame and right frame to said user within said 3D viewing apparatus. In further embodiments the 3D viewing apparatus may be configured to provide user input to the image processing engine. In these embodiments, user input may comprise a change in orientation of the user's view.

In a further embodiment, a virtual reality camera system includes a virtual reality camera, a network, external storage, a server, and a plurality of clients. In one embodiment, the clients comprise 3D viewing headsets comprising two OLED screens, wherein each OLED screen is viewable by only one eye.

In yet another embodiment, a method of recording and presenting a 3D video includes capturing a stereoscopic image having a left and right wide-angle view using two wide-angle lenses. The left and right wide-angle views are then de-warped to create left and right panorama views. An initial fixation point is selected that corresponds to a single position within the left and right panorama views. Next, a subset of each panorama view is created by framing a portion of the panorama view having the fixation point at or near its center. The resulting framed view, when zoomed in, resembles a perspective view and can be viewed in a stereoscopic 3D viewer to simulate a 3D environment. In response to user input, such as a head tracking sensor or other means, the fixation point is adjusted to a new position. Accordingly, the framed view is also updated and the adjusted view is presented within the 3D viewer, simulating true immersion for an end user.

### BRIEF DESCRIPTION OF THE DRAWINGS

The following figures depict certain illustrative embodiments of the methods and systems described herein, in which like numerals refer to like elements. These depicted embodiments are to be understood as illustrative of the disclosed methods and systems and not as limiting in any way.

FIG. 1 is a block diagram illustrating an embodiment of a virtual reality camera system;

FIG. 2 is a perspective view of the front of a virtual reality camera of FIG. 1;

FIG. 3 is a perspective view of the back of the virtual reality camera of FIG. 1; and

FIG. 4 is a flow diagram of a process for creating pannable stereoscopic images or videos.

### DETAILED DESCRIPTION OF THE DISCLOSURE

The detailed description set forth below in connection with the appended drawings is intended as a description of embodiments and does not represent the only forms which may be constructed and/or utilized. However, it is to be understood that the same or equivalent functions and sequences may be accomplished by different embodiments that are also intended to be encompassed within the spirit and scope of the disclosure, such as virtual reality cameras and virtual reality camera systems of different sizes, dimensions, components, and materials.

The present disclosure features a novel system, apparatus, and method for recording and displaying three-dimensional images and videos. As discussed above, the prior art includes cameras that can capture stereoscopic images. However, said cameras have not provided high resolution images or immersive, wide-angle views, nor have they allowed the views to be streamed in real-time to a separate viewing device. Described herein are embodiments of virtual reality cameras that can be used to provide stereoscopic views to a virtual reality headset or other 3D viewing device. The virtual reality cameras are mobile and amateur accessible, thus placing 3D video recording in the hands of the average consumer. The stereoscopic views can be presented in real-time, or recorded and presented later. Further, the stereoscopic views are pannable, allowing the user to “look around” the view within a virtual reality headset. Applications include augmented reality, gaming, filmmaking, social networking, conferencing, news reporting, sports, and any other form of media that would benefit from a simulated virtual presence.

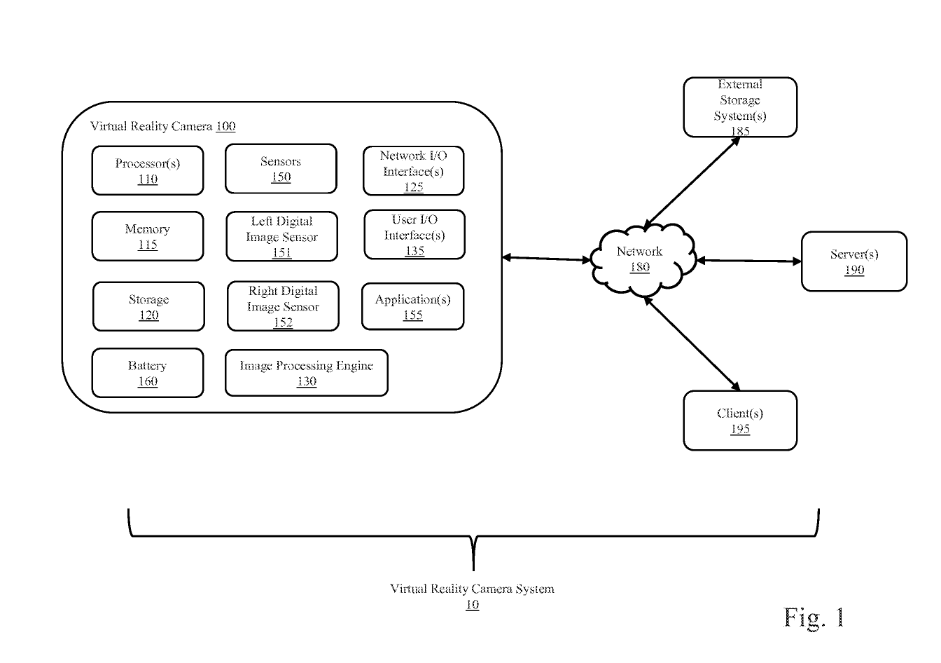

FIG. 1 illustrates various internal hardware and software components in an example embodiment of a virtual reality camera system 10. The virtual reality camera system 10 features a virtual reality camera 100, which may be any form of computing or electronic device, such as a digital camera, mobile phone, smart phone, personal digital assistant, or tablet device. The camera 100 may be wearable; for example, the camera 100 may be embedded into a pair of smart glasses or a headset. Further, the camera 100 may be embodied as a stand-alone system, or as a component of a larger electronic system within any environment.

The camera 100 can comprise a processor 110, memory 115, and storage 120. The processor 110 may be any hardware or software-based processor, and may execute instructions to cause any functionality, such as applications, clients, and other agents, to be performed. Instructions, applications, data, and programs may be located in memory 115 or storage 120. Further, an operating system may be resident in storage 120, which when loaded into memory 115 and executed by processor 110, manages most camera hardware resources and provides common services for computing programs and applications to function.

The camera 100 can communicate with other devices and computers via a network 180. The network can be any network, such as the Internet, cell phone network, or a local Bluetooth network. In some embodiments, the camera 100 can communicate with one or more external storage systems 185, servers 190, clients 195, or other sites, systems, or devices hosting external services to access remote data or remotely executing applications.

Further, the camera 100 may access the network 180 via one or more network input/output (I/O) interfaces 125. The network I/O interfaces allow the camera 100 to communicate with other computers or devices, and can comprise either hardware or software interfaces between equipment or protocol layers within a network. For example, the network I/O interfaces may comprise Ethernet interfaces, frame relay interfaces, cable interfaces, DSL interfaces, token ring interfaces, wireless interfaces, cellular interfaces, and the like.

An end user may interact with the camera 100 via one or more user I/O interfaces 135. User I/O interfaces 135 may comprise any input or output devices that allow an end user to interact with the camera 100. For example, input devices may comprise various buttons, a touch screen, microphone, keyboard, touchpad, joystick, and/or any combination thereof. Output devices can comprise a screen, speaker, and/or any combination thereof. Thus, the end user may interact with the camera 100 by pressing buttons, tapping a screen, speaking, gesturing, or using a combination of multiple input modes. In turn, the camera 100 or other component may respond with any combination of visual, aural, or haptic output. The camera 100 may manage the user I/O interfaces 135 and provide a user interface to the end user by executing a stand-alone application residing in storage 120. Alternately, a user interface may be provided by an operating system executing on the camera 100.

Additionally, the camera 100 may contain a number of sensors 150 that can monitor variables regarding an end user, the camera 100, and/or a local environment. Sensors 150 may include sensors that monitor the electromagnetic spectrum, device orientation, or acceleration. Accordingly, the sensors 150 may comprise one or more of an infrared sensor, gyroscope, accelerometer, or any other sensor capable of sending light, motion, temperature, magnetic fields, gravity, humidity, moisture, vibration, pressure, sound, electrical fields, or other aspects of the natural environment. The sensors 150 may further comprise a pair of digital image sensors, such as a left digital image sensor 151 and a right digital image sensor 152. Each digital image sensor 151, 152 may simultaneously capture an image to create a stereoscopic view.

The camera 100 may further comprise a number of applications 155, which may be implemented in hardware or software. The applications may make use of any component of the camera 100 or virtual reality camera system 10. Further, the applications may be located on an external server 190 or access data stored on external storage 185. In such cases, the camera 100 may access applications 155 through network 180 via the network I/O interfaces 125.

Applications 155 may comprise any kind of application. For example, applications 155 may relate to processing of images captured by the camera 100. Additionally, applications 155 may relate to social networking, sports, GPS navigation, e-mail, shopping, music, or movies. Further, applications 155 may communicate and exchange data with other applications executing on the camera 100.

In some instances, applications 155 can include an application for determining the geographic location of the camera 100. For example, the location application can communicate with a remote satellite to determine the geographic coordinates of the camera 100. Upon receiving the geographic coordinates, the location application can forward the coordinates to any application executing on the camera 100 that wishes to know the current location of the camera 100. For example, an application may embed information regarding the current geographic location within a recorded 3D video file. Applications 155 may also include speech recognition, natural language understanding, text-to-speech, or intelligent assistants.

Camera 100 can also comprise an image processing engine 130. In this embodiment, image processing engine 130 can comprise software routines loaded in memory 115 and executing on processor 110 to process images captured by the left and right digital image sensors 151, 152. However, in other embodiments, components of image processing engine 130 may also be implemented in hardware, or be executed on or accessed from external servers 190 or clients 195. Image processing engine 130 may also store images in memory 115 or storage 120, compress images, convert images between different file formats, adjust lighting, hue, or saturation, crop, zoom, warp, de-warp, or perform additional corrections and alterations.

In some embodiments, the digital image sensors 151, 152 and image processing engine 130 may make use of the various applications 155 or sensors 150 on the camera 100. For example, the image processing engine 130 may use information from motion- or vibration-detection sensors to detect any shaking of the camera 100 during image capture. This information can be used for image stabilization and to reduce any shaking or blurring within the image.

Further, the camera 100 comprises a battery 160 which is used to provide electrical power to all of the components of the device. In various embodiments, the battery 160 may be rechargeable, such as a lithium ion (Li-ion) or nickel metal hydride (NiMH) battery. The battery 160 may also be removable or single-use. Alternately, in other embodiments the camera 100 may lack a battery and rely on an exterior power source.

In certain embodiments, captured stereoscopic images may be viewed directly on a display of the camera 100 itself. Captured images or video may also be displayed by an external 3D viewer or viewing apparatus, such as by a client 195. Clients 195 can comprise any kind of 3D viewer or apparatus, such as a virtual reality headset with two OLED screens, wherein each OLED screen is viewable by only one eye. Clients 195 may also be a 3D television or other form of 3D display, such as a handheld unit. Clients 195 may access stored 3D images or video directly from the camera 100 over network 180, or alternately from external storage 185 or various servers 190.

Clients 195 may use a variety of means to display 3D images. For example, 3D viewers may use active shutter systems, wherein a single display presents an image for the left eye while blocking the right eye view, and then presents the right eye image while blocking the left eye view. This process is repeated at a sufficient rate so that the interruptions do not interfere with the perceived fusion of the two images into a single 3D image. 3D viewers can also comprise passive systems, such as polarization systems. In these cases, two images are projected onto a screen through a polarizing filter. The viewer then wears low-cost eyeglasses which contain a pair of opposite polarizing filters, thus presenting a different image to each eye. Various other 3D viewers are known in the art and may be used to view captured stereoscopic images and video from the virtual reality camera 100.

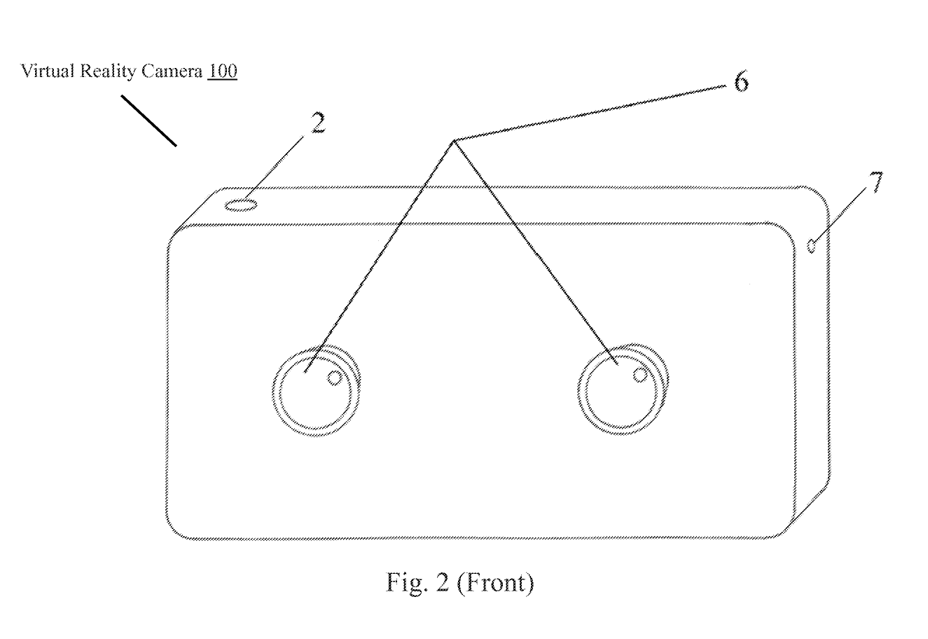

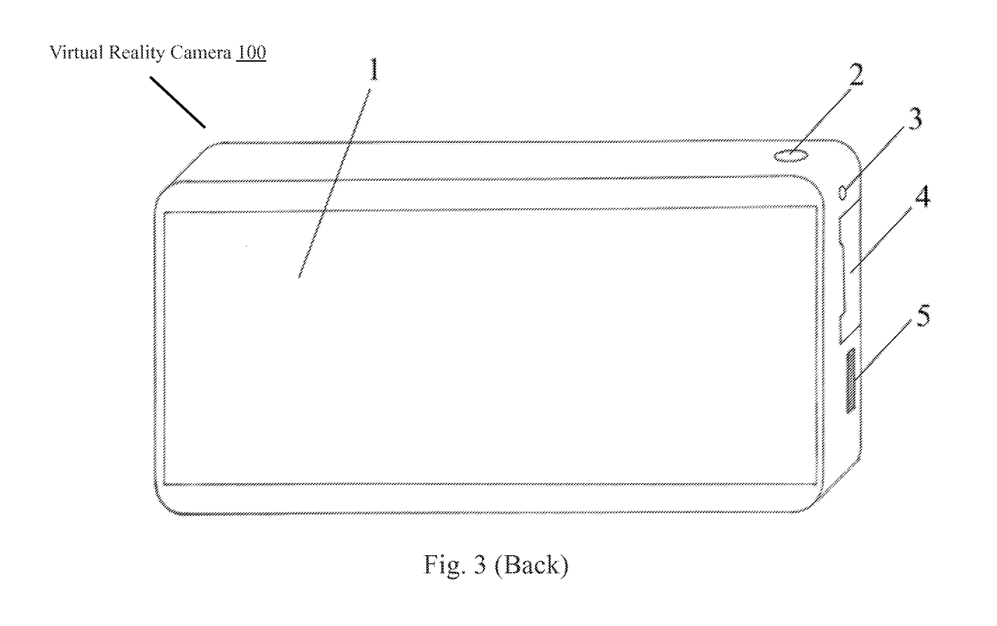

FIG. 2 is a perspective view of the exterior front of a mobile virtual reality camera 100 according to one embodiment of the disclosure. In this embodiment, the camera 100 features two ultra-wide-angle lenses 6, also known as “fisheye” lenses. The front of the camera 100 further features a left microphone 7 and a power button 2. FIG. 3 is a perspective view of the exterior back of the virtual reality camera 100 as shown in FIG. 2. The back of the virtual reality camera 100 features an autostereoscopic touch screen 1, a right microphone 3, a memory card slot 4, and a USB port 5. In this embodiment, the camera is shaped as a cuboid. However, alternate configurations and shapes may be used.

For purposes of the disclosure, the phrase “fisheye lens” refers to an ultra-wide angle lens that produces a curvilinear image featuring a strong visual distortion. In contrast to images captured by a rectilinear lens, fisheye lenses will render straight lines in an image as curved. Further, objects in the center of the image are particularly enlarged, especially if the image is captured from a short distance. However, fisheye lens are able to capture very wide fields of view, such as between 100 and 180 degrees. With appropriate software, the curvilinear images produce by a fisheye lens can be converted to a conventional rectilinear (straight-line) projection. The resulting converted image creates a panoramic view. As will be described in further detail below, portions or all of the panoramic view may be de-warped and zoomed to provide a 3D first person view, which may be panned across the panoramic view to provide the illusion of immersion within a 3D environment.

In this embodiment, the two fisheye lenses 6 are spaced apart at about 63 mm, mimicking the average interocular distance of human eyes. The fisheye lenses 6 preferably have an angle of view between 100 and 180 degrees, allowing the lens to capture an expansive background. As light enters the lens, it is captured by the left or right digital image sensors 151, 152 and converted into an array of pixels to create an image. The image is then processed by image processing engine 130 executing on processor 110 and transferred to storage 120. However, in other embodiments, lenses with other angles of view may be used.

A variety of digital image sensors may be used. Sensor resolution may range depending on the application. For example, the sensor may be able to capture several megapixels (1,000,000 pixels) of information for an image. For video, the sensor may capture sufficient pixels to create standard definition (480i), high definition (1080p), or even ultra-high definition (4K) image streams. In this embodiment, each fisheye lens 6 has its own digital image sensor 151, 152. However, in certain embodiments, the fisheye lenses 6 can share a single digital image sensor and the resulting image is then divided into portions corresponding to each lens.

Captured images and video may be stored locally on the camera 100, such as on storage media within a storage media slot 4. A variety of storage media may be used, such as SD format or CompactFlash. Stored images and video may also be transferred to a separate computer or server via a USB cable attached to the USB port 5 or via a wireless connection, such as network input/output (I/O) interface 8. In some embodiments, captured images or video may be viewed in real-time on a client 195 by streaming the images or video over a wireless connection via the network 180.

The virtual reality camera 100 may capture images with either the left or right fisheye lenses 6, or both. If both lenses are used, left and right images are captured simultaneously. The images may be stored together in a single file format, or alternately stored as separate files. For example, suitable file formats for stereo images include Multi-Picture Object (MPO), which consists of multiple JPEG images; PNG Stereo Format (PNS), which consists of a side-by-side image using the Portable Network Graphic (PNG) standard; and JPEG Stereo Format (JPS) which consists of a side-by-side format based on JPEG. Alternatively, the left and right images may be saved separately in a single-image file format and named accordingly so that the two files are linked. For video, suitable 3D file formats include MTS, MPEG4-MVC, and AVCHD. During video capture, left and right microphones 7, 3 may also capture binaural audio and encode said audio within the video file. The binaural audio may be played back with the video file, thus provide a 3D stereo sound sensation.

Captured images or video may be displayed immediately on the integrated autostereoscopic touch screen 1. In other embodiments, other kinds of autostereoscopic displays can be used including lenticular lens, volumetric display, holographic, and light field displays. As explained above, captured images or video may also be transmitted to and displayed by an external 3D viewer or viewing apparatus such as a client 195.

In operation, an end user holds the virtual reality camera 100 with the front (i.e., as shown in the embodiment of FIG. 2) facing the desired scene to be captured and the back (i.e., as shown in the embodiment of FIG. 3) facing the end user. The end user may then initiate recording processes via the user I/O interface 135, such as through a menu displayed on the autostereoscopic touch screen 1. In other embodiments, the end user may take a picture or begin recording by pressing a dedicated button on the camera 100. The autostereoscopic touch screen 1 may also display a menu or other kinds of information superimposed over the displayed image, providing a composite view. The user is free to quickly and easily create 3D images and videos because the camera is light, portable, and movable.

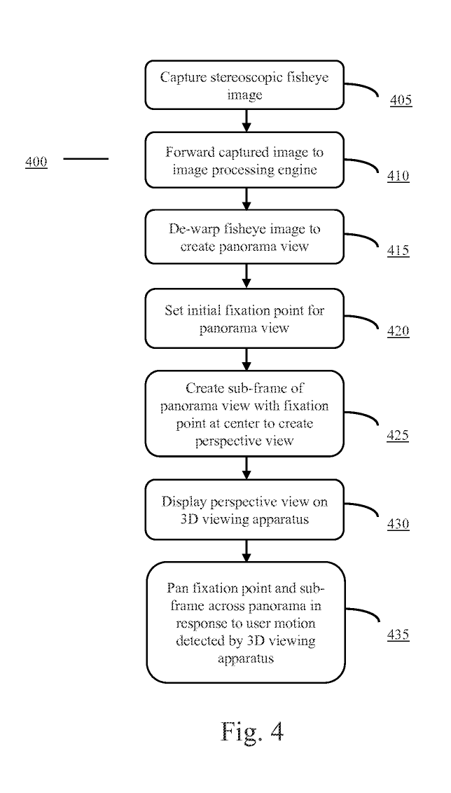

FIG. 4 is a flow diagram illustrating a method 400 of capturing and displaying 3D-pannable images or videos using a virtual reality camera system 10 in accordance with one embodiment. A virtual reality camera (such as the virtual reality camera 100 of FIGS. 1-3) captures a stereoscopic fisheye image comprising left and right wide-angle views, (Step 405) and forwards the captured image to the image processing engine 130 (step 410). The image processing engine 130 then de-warps each wide-angle view to create left and right panorama views (step 415). Once de-warped, an initial 3D focal point, or fixation point, is selected (step 420) and a perspective view is defined as a sub-frame of each panorama view (step 425). The perspective view can then be displayed in an appropriate 3D viewing apparatus (step 430). The perspective view may be adjusted in response to user motion or other input. For example, an integrated head tracking device can provide information used to pan the view in any direction in response to user motion or any other form of user input (step 435). Method 400 may be applied to stereoscopic images, frames of 3D videos, or any other form of visual media that simulates a 3D view.

Further referring to FIG. 4, and in more detail, the virtual reality camera 100 captures a stereoscopic image or video using two digital image sensors 151, 152 in communication with two fisheye lenses 6, which are set sufficiently apart to create a stereo view (step 405). In one embodiment, the lens centers are separated by a distance that falls within the average human interpupillary distance (IPD), from 50-75 mm. For example, the lens centers may be separated by 63 mm. In these cases, the captured video will better simulate a view from human eyes.

The captured stereoscopic image may then be forwarded to an image processing engine, such as the image processing engine 130 which executes on the processor 110 of the camera 100 of FIG. 1 (step 410). In this embodiment, the image processing engine 130 executes locally on the camera 100. However, certain embodiments, the image processing engine can be located externally, such as on a server 190. In this case, captured images may then be streamed to the server 190 over the network 180. In other embodiments, the image processing engine 130 may be distributed across multiple systems.

The image processing engine 130 may process either individual still images or entire videos. In the latter case, the image processing engine 130 may process a video simply as a set of still image frames. The image processing engine 130 may also process images sequentially or in any order; however, the image processing engine will appropriately format and link the two images forming a stereoscopic view together so that they can later be displayed simultaneously in a 3D view.

Further, when processing video, the image processing engine 130 may seek to synchronize left and right video streams according to timestamps embedded within the frames. In another embodiment, the image processing engine 130 may also seek to align the videos using visual cues present in the individual frames. Such alignment may be necessary in situations where either the left or right video stream is out of alignment due to a loss of frames or other interruption.

Next, the image processing engine 130 begins to process the stereoscopic image to create a pannable 3D video. Due to the ultra-wide-angle view captured by the fisheye lenses 6, images captured by the camera 100 are curvilinear and feature a strong visual distortion. Fisheye lenses achieve extremely wide fields of view by forgoing the perspective mapping common to non-fisheye lenses, which directly map straight lines from a captured scene to straight lines in an image. Instead, fisheye lenses create an image with a radial distortion in which image magnification decreases with distance from the optical axis. This results in “barrel distortion,” in which the apparent effect is that of an image that has been mapped around a sphere.

Curvilinear, or fisheye, views can be corrected and de-warped to create panoramic views with large horizontal fields of view that are suitable for embodiments of cameras and 3D viewers according to the disclosure. Digital images may be de-warped in software, for example, by the image processing engine 130. Briefly, de-warping an image involves determining which distorted pixel corresponds to each undistorted pixel. In one embodiment, the image processing engine 130 de-warps an image by stretching the corners image outward and pinching the sides inward, thus creating a panorama view (step 415). The resulting panorama view still features some distortion due to the wide field of view, but the “barrel distortion” effect has been modified to completely fill the frame. Further, de-warping may be separately applied to Red, Green, and Blue channels of an image to significantly reduce lateral chromatic aberration. Other algorithms and methods for converting fisheye views to panorama views are known in the art and may be substituted.

Once the fisheye views have been processed to create panorama views, an initial 3D focal point, or fixation point, may be selected (step 420). To provide a comfortable 3D viewing experience for the viewer, the fixation point should correspond to a single object or point represented in both the left and right views. In one embodiment, an end user may set the fixation point while using the camera 100 by way of the autostereoscopic touch screen 1. In another embodiment, the camera 100 may use a built-in sensor that is able to auto-sense an object's distance, and thus set the correct fixation points to correspond to the correct parallax for that object. Failure to properly define a fixation point for each image may result in an inability to properly display the resulting stereo view because the parallax is set incorrectly. For example, misplaced fixation points that correspond to one object in the left view and another object in the right view may result in a viewer being unable to properly focus on a single object, resulting in double vision (diplopia).

Next, the image processing engine 130 frames a subset of the panoramic view with the fixation point at or near the center of the view, creating a perspective view (step 430) comprising only the framed portion or subset of the panoramic view. Because the view has been “zoomed,” the resulting perspective view does not feature noticeable distortion from the full panorama view. This perspective view can then be zoomed in and viewed with a suitable 3D image viewer, such as a head mounted display, autostereoscopic screen, active shutter system, or the like. The perspective view may also be displayed in real-time on the autostereoscopic touch screen 1 of the camera. Succeeding frames of perspective views may be displayed at a sufficient number of frames per second (fps) to play video.

Fixation points can be set and updated in a variety of ways. If a fixation point is selected by the camera 100, it may be recorded and stored with the resulting pair of captured left and right images. If the camera 100 is recording video, fixation points may be captured for each frame. The viewer of the video is then initially provided with the 3D view selected by the camera operator.

A viewer may also update the fixation points while viewing the video, whether the video is live-streamed or played back as a recording. For example, as the perspective view is displayed to an end user in an appropriate 3D viewing device, the user may pan the view in any direction (step 435). In response, the image processing engine 130 can pan the fixation point to a new position within the panorama view, create a new sub-frame within the panorama, and present the resulting adjusted perspective view to the viewer. As this effect is processed in real-time, the experience of “looking around” within a virtual 3D view is simulated.

The user may pan the view in a variety of ways. For example, if the user is viewing the perspective view on an autostereoscopic touch screen 1 on a virtual reality camera 100, the user may simply touch the screen to drag the perspective view across the panorama. On the other hand, if the user is wearing a head-mounted display, an integrated head-tracking device can instantaneously report head movements or changes in orientation to the image processing engine 130 to update the fixation point and pan the view accordingly. In certain embodiments, the user's eyes may also be tracked to determine the user's current view. In this way, the user does not need to press any buttons to change the view; instead, the user is immersed in a virtual world, and can look around simply by moving his or her head.

In some embodiments, video is recorded and played back at 24 fps. In other embodiments, video is recorded and played back at higher rates. High frame rates are desirable if the video is captured while in motion, or if the camera pans quickly in a direction. In such cases, if the frame rate is low (e.g., less than 24 fps), the viewer may experience the video as having a high degree of motion blur. Increasing the frame rate should reduce this effect. Further, if the frame rate is very low (e.g., <10 fps) such that the video appears to be “choppy,” the viewer may experience an undesirable feeling of nausea.

Method 400 may be distributed across multiple computing devices. For example, the camera 100 or an external server 190 may perform functions of the image processing engine 130 related to the initial de-warping of the stereoscopic fisheye image. A client 195, such as a virtual reality headset with head-tracking device, may then set the initial fixation point and framed perspective views, and update accordingly in response to user input. Further, in some embodiments, information regarding the fixation points and perspective views are contained within the media file, and the view will update accordingly during playback of a 3D video or image.

Further, the steps of method 400 may be practiced in any order or by any component of the virtual reality camera system 10. In addition, some steps may be omitted, repeated, or performed by multiple devices. In certain embodiment, additional steps may also be included.

In one embodiment, the camera 100 can be part of a 3D broadcasting system. Whereas 3D cameras that physically move in response to a VR headset may only be viewed by a single viewer, a panorama view captured by embodiments described above may be viewed by any number of people with appropriate software to set fixation points and create perspective views. In this way, panorama images and videos may be created by a camera 100 and the perspective views may then be created locally on a 3D headset or client 190.

In some embodiments, a 3D video or image may be processed first, stored on a server, and then viewed later with an appropriate device. In other embodiments, image capture, processing, and viewing occur nearly simultaneously and in a streaming fashion. For example, in one embodiment, a “live stream” of an event is captured with a virtual reality camera 100 within a virtual reality camera system 10. The resulting stereoscopic images are partially processed by a local image processing engine 130 and then transferred to a server 190. An end user may then use a client 195, such as a network-enabled head-mounted display with a head-tracking device, to access the server 190 to view the live stream. The end user can then “look around” the live stream of the video using the integrated head-tracking device. In this way, the end user is able to remotely experience an event in an immersive manner. The client 195 may also communicate directly with the camera 100, as opposed to accessing a file from the server 190.

Having described an embodiment of the technique described herein in detail, various modifications and improvements will readily occur to those skilled in the art. Such modifications and improvements are intended to be within the spirit and scope of the disclosure. Accordingly, the forgoing description is by way of example only, and is not intended as limiting. The techniques are limited only as defined by the following claims and equivalents thereto.

What is claimed is:

1. A virtual reality camera comprising:
a left wide-angle lens in communication with a left digital image sensor;
a right wide-angle lens in communication with a right digital image sensor;
a storage device, a processor, and a memory; and
an image processing engine executing on the processor and configured to process a left image captured by the left digital image sensor and a right image captured by the right digital image sensor to create a pannable stereoscopic view.

2. The virtual reality camera of claim 1, wherein the left wide-angle lens and the right wide-angle lens comprise a left ultra-wide-angle lens and a right ultra-wide angle lens.

3. The virtual reality camera of claim 1, wherein the image processing engine is further configured to de-warp the left image and the right image to create a panoramic left image and a panoramic right image.

4. The virtual reality camera of claim 3, wherein the image processing engine is further configured to set an initial fixation point for the panoramic left image and the panoramic right image.

5. The virtual reality camera of claim 4, wherein the image processing engine is further configured to create a left perspective view and a right perspective view from the panoramic left image and the panoramic right image, wherein each perspective view comprises a framed portion of each respective panoramic view with each respective fixation point at its center.

6. The virtual reality camera of claim 5, wherein the pannable stereoscopic view comprises the left perspective view and the right perspective view.

7. The virtual reality camera of claim 1, further comprising an autostereoscopic screen.

8. The virtual reality camera of claim 7, wherein the pannable stereoscopic view is displayed in real-time on the autostereoscopic screen.

9. A method of recording a three-dimensional (3D) video, comprising:
capturing, with a left wide-angle lens and a right wide-angle lens, a stereoscopic image comprising a left fisheye view and a right fisheye view;
de-warping the left fisheye view and the right fisheye view, by an image processing engine executing on a processor, to create a left panorama view and a right panorama view;
setting an initial fixation point that corresponds to a single position within the left panorama view and the right panorama view;
creating a left frame within the left panorama view having the fixation point at the center of the frame, and a right frame within the right panorama view having the fixation point at the center of the frame; and
presenting the left frame and right frame to a user within a 3D viewing apparatus.

10. The method of recording a three-dimensional (3D) video of claim 9, wherein presenting the left frame and the right frame to a user comprises streaming the left frame and the right frame to an external server.

11. The method of recording a three-dimensional (3D) video of claim 9, further comprising:
updating, in response to user input, the fixation point to a new position;
updating the left frame and right frame in response to the updated fixation point; and
presenting the updated left frame and right frame to the user within the 3D viewing apparatus.

12. The method of recording a three-dimensional (3D) video of claim 11, wherein user input comprises a change in orientation of the user's view.

13. The method of recording a three-dimensional (3D) video of claim 11, wherein user input comprises feedback received from a touch screen.

14. The method of recording a three-dimensional (3D) video of claim 11, wherein updating the left frame and right frame in response to the updated fixation point comprises creating a left frame within the left panorama view having the updated fixation point at the center of the frame, and a right frame within the right panorama view having the updated fixation point at the center of the frame.

15. A system for recording a three-dimensional (3D) video, comprising:
a left wide-angle lens in communication with a left digital image sensor;
a right wide-angle lens in communication with a right digital image sensor;
at least one 3D viewing apparatus; and
an image processing engine executing on a processor and configured to:
capture, with the left wide-angle lens and the right wide-angle lens, a stereoscopic image comprising a left fisheye view and a right fisheye view;
de-warp the left fisheye view and right fisheye view to create a left panorama view and a right panorama view;
set an initial fixation point that corresponds to a single position within the left panorama view and the right panorama view;
create a left frame within the left panorama view having the fixation point at the center of the frame;
create a right frame within the right panorama view having the fixation point at the center of the frame; and
present the left frame and right frame to a user within the 3D viewing apparatus.

16. The system for recording a three-dimensional (3D) video of claim 15, further comprising an external server, wherein presenting the left frame and the right frame to a user comprises streaming the left frame and the right frame to the external server.

17. The system for recording a three-dimensional (3D) video of claim 16, wherein the 3D viewing apparatus is configured to receive the left frame and the right frame from the external server.

18. The system for recording a three-dimensional (3D) video of claim 17, wherein the image processing engine is further configured to:
update, in response to user input, the fixation point to a new position;
update the left frame and right frame in response to the updated fixation point; and
present the updated left frame and right frame to the user within the 3D viewing apparatus.

19. The system for recording a three-dimensional (3D) video of claim 18, wherein the 3D viewing apparatus is configured to provide user input to the image processing engine.

20. The system for recording a three-dimensional (3D) video of claim 19, wherein user input comprises a change in orientation of the user's view.
